(19) United States
(12) Patent Application Publication
(10) Pub. No.: US 2003/0051022 A1
(43) Pub. Date: Mar. 13, 2003

(54) Web page management support system

(76) Inventors: Masaru Sogabe, Tokyo (JP); Isao Tabuchi, Yokohama-shi (JP)

Correspondence Address: CANTOR COLBURN, LLP, 55 GRIFFIN ROAD SOUTH, BLOOMFIELD, CT, 06002

(21) Appl. No.: 10/125,534

(22) Filed: Apr. 18, 2002

(30) Foreign Application Priority Data
Sep. 10, 2001 (JP) 2001-274211

(51) Int. Cl. G06F 15/173

(52) U.S. Cl. 709/223

(57) ABSTRACT

Improved convenience and simplified web page management and updating.

On the basis of a layout definition file L provided from a web server (11), a content acceptable area is laid out and displayed at a manager terminal (21), and while viewing this, the manager lays out the content. Information on content assignment is uploaded to the web server (11) as a data definition file D. The web server (11) generates and sends to a customer terminal (30) a web page on the basis of the data definition file D and a generation instruction file S.

### BACKGROUND OF THE INVENTION

1. Field of the Invention

The present invention relates to a system for supporting the management of web pages provided via a network.

2. Description of the Related Art

In recent years, various businesses have set up web sites and operate them for selling merchandise over the Internet. In general, the operation and maintenance of these web sites for selling merchandise are extremely complex so that the present circumstances do not yet allow the managers of small and medium sized stores to easily set up their own web sites. Amid this setting, services have appeared for providing basic web site designs, and if information on merchandise to be sold is registered in a database, services are available for setting up web sites (virtual stores) for selling the merchandise.

As shown in FIG. 11, a system (electronic commerce system) for performing this service basically comprises a web server 1 and a database 2 located at the service dealer, and a manager terminal 3 located at a store where the web site is to be managed, with these components mutually connected via a network.

The web server 1 generates a web page by referencing a generation instruction file that has been defined in advance, and loading real data of the content stored in the database 2. Normally, the web server 1 dynamically generates web pages as soon as they are requested by a customer. The database 2 manages the merchandise information received from the store. The database 2 generally manages a plurality of master tables (tables correlating keys and data). Examples of master tables are a store master table relating to store data, a merchandise master table relating to merchandise data, and an image master table relating to image data, such as merchandise photographs. The manager terminal 3 is generally a personal computer installed with software for performing registration to the database 2.

In a conventional electronic commerce system, when providing a web page to introduce merchandise, for example, the following process is performed to correlate the merchandise information registered by the manager with the position of the information on the web page to be generated by the generation instruction file. Namely, the software for performing registration to the database 2 provides an interface as shown in FIG. 12 to the web page manager at the store, and registers a merchandise master table from the input of text or numeric values into the merchandise quantity field, merchandise image field, merchandise description field, and merchandise selling price field. Furthermore, an image is uploaded separately to the database 2 and its file name is written as text and registered to the image master table. The input data (merchandise master table and image master table) is then registered to the database 2, and the web server 1 references the merchandise master table and the image master table registered in the database 2 in accordance with the generation instruction file and loads the various data to generate a web page for which links have been set.

When a customer performs operations to select merchandise on this web page, a web page for performing order processing is provided according to a link setting, and inputs of information, such as for the delivery address, are accepted. A web page specifying payment information and so forth is next provided, and a program for performing order processing is started. The merchandise selection page, delivery address information setting page, and payment information input page provided here and the program that functions in cooperation with these pages as a whole constitute the web site.

In this conventional system, a tenant need not be concerned with the structure of the web site. Namely, the tenant can set up an electronic commerce site simply by using the above-mentioned database operation and registering information (merchandise master table) on the merchandise to be listed on the page for merchandise selection. Furthermore, a merchandise photograph can be replaced by using the above-mentioned database operation and changing the image master table.

However, since the merchandise master table is generated from character string inputs in the above-mentioned conventional system, the final web page to be presented to the customer cannot be confirmed until after completion of the database, thereby resulting in an inconvenient system. Furthermore, since it is necessary to separately maintain the plurality of master tables, the system is inconvenient also in this respect.

### SUMMARY OF THE INVENTION

It is therefore an object of the present invention with the above-mentioned circumstances in consideration to provide a web page management support system capable of updating web pages through simple operations with improved convenience.

The present invention for solving the problems of the above-mentioned conventional example is a web page management support system comprising a database for storing the real data of contents, a web server, and a manager terminal disposed at the location of the manager of a web page. The manager terminal includes a device for presenting to the manager a layout definition file that includes layout information of content acceptable areas and corresponds to a generation instruction file, a device for generating according to instruction from the manager a data definition file that correlates the real data of contents to the content acceptable areas, and a device for sending the data definition file to the web server. On the basis of the data definition file, the real data of contents is loaded from the database, arranged according to the generation instruction file, and provided as a web page.

According to the present invention, the content acceptable areas are laid out, and while viewing this, the manager can lay out the contents for improved convenience. Furthermore, since the real data is correlated to areas, the correlation data need not be changed even though the area layout is changed, thus allowing easy updating and management of web pages.

It is also preferable for each of a plurality of content acceptable areas to be divided into one of a plurality of area groups, a plurality of layout definition files having layout information of acceptable areas of an area group for every area group to be defined, the manager terminal to generate a plurality of data definition files corresponding to respective layout definition files, the real data of the contents to be loaded from the database on the basis of the plurality of data definition files, and the web page to be arranged according to the generation instruction file and provided from the web server.

According to one aspect of the present invention, a web page management support apparatus connected to a database storing the real data of contents and to a web server, includes a presenting device for presenting to the manager a layout definition file that includes layout information on the content acceptable areas and corresponds to the generation instruction file, a generating device for generating according to instruction from the manager a data definition file that correlates the real data of the contents to the content acceptable areas, and a sending device for sending the data definition file to the web server. The real data of the contents is loaded from the database on the basis of the data definition file and laid out according to the generation instruction file to provide the web page from the web server.

It is preferable to further include a device for page design for outputting the generation instruction file and the data definition file that corresponds to the generation instruction file. Furthermore, it is preferable for the generating device to generate a data definition file to include instructions for setting a link to at least one content acceptable area.

It is also preferable for each of a plurality of content acceptable areas to be divided into one of a plurality of area groups, a plurality of layout definition files having layout information of acceptable areas of an area group for every area group to be defined, the generating device to generate a plurality of data definition files corresponding to respective layout definition files, the real data of the contents to be loaded from the database on the basis of the plurality of data definition files, and the web page to be laid out according to the generation instruction file and provided from the web server.

According to another aspect of the present invention, a web page management support method, using a database storing real data of contents and a web server, includes a process for presenting to a manager a layout definition file that includes layout information of content acceptable areas and corresponds to the generation instruction file, a process for generating according to instruction from the manager a data definition file that correlates the real data of the contents to the content acceptable areas, and a process for sending the data definition file to the web server. The real data of the contents is loaded from the database on the basis of the data definition file and laid out according to the generation instruction file so that a web page for which links have been set is provided from the web server.

Furthermore, according to another aspect of the present invention, a web page management support program executing on a computer that is connected to a database storing the real data of contents and to a web server, executes a process for presenting to the manager a layout definition file that includes layout information on the content acceptable areas and corresponds to the generation instruction file, a process for generating by instruction from the manager a data definition file that correlates the real data of the contents to the content acceptable areas, and a process for sending the data definition file to the web server. The real data of the contents is loaded from the database on the basis of the data definition file and laid out according to the generation instruction file so that a web page for which links have been set is provided from the web server.

Furthermore, according to another aspect of the present invention, a method for providing a web site provider service using a database storing the real data of contents and a web server, comprises a process for providing to a manager a layout definition file that includes layout information of content acceptable areas and corresponds to the generation instruction file, and a process for accepting from the manager the data definition file correlating the real data of the contents with the content acceptable areas. The real data of the contents is loaded from the database on the basis of the data definition file and laid out according to the generation instruction file so that a web page for which links have been set is provided from the web server.

### BRIEF DESCRIPTION OF THE DRAWINGS

FIG. 1 is a block diagram showing the configuration of the web page management support system relating to an embodiment of the present invention.

FIG. 2 is a block diagram showing the configuration of the manager terminal.

FIG. 3 illustrates an example of the contents of the data definition file D.

FIG. 4 illustrates the contents of the layout definition file L and an example of a display thereof.

FIG. 5 illustrates an example of a user interface of the web page management support program that executes on the manager terminal.

FIG. 6 illustrates an example of a web page that is generated from a data definition file D.

FIG. 7 illustrates an example of a frame.

FIG. 8 illustrates the contents of another example of the data definition file D.

FIG. 9 illustrates the contents of yet another example of the data definition file D.

FIG. 10 illustrates the contents of yet another example of the data definition file D.

FIG. 11 is a block diagram showing an example of a conventional electronic commerce system.

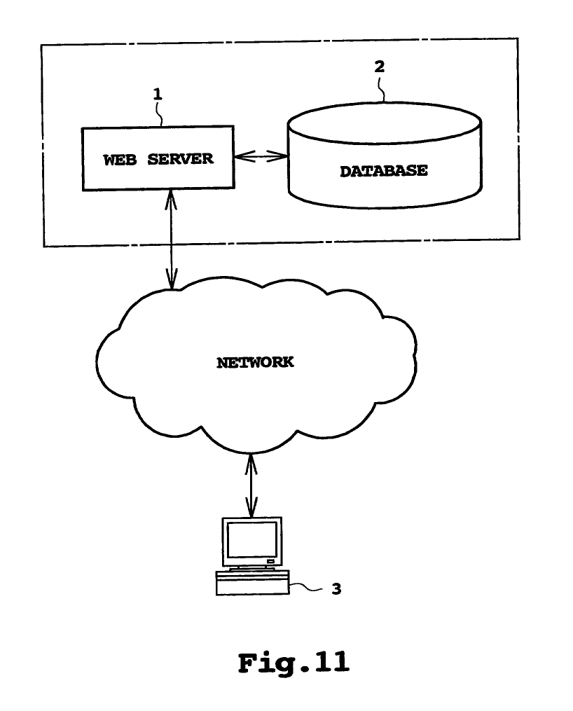

FIG. 12 illustrates an example of an interface of a conventional database management tool.

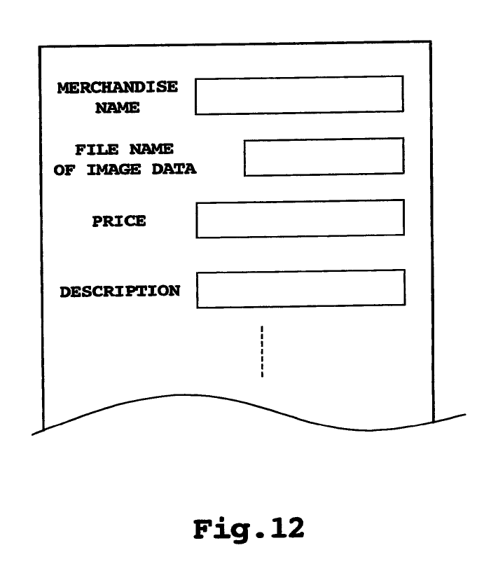

### DETAILED DESCRIPTION OF THE PREFERRED EMBODIMENTS

The web page management support system relating to embodiments of the present invention will be described with reference to the attached drawings. In the description hereinafter, examples applied to electronic commerce systems will be given. However, it should be noted that the web page management support system of the present embodiments can be utilized not only in electronic commerce systems but also in the maintenance of general web sites, and even when it is applied to electronic commerce systems, it can be utilized not only for the replacement of merchandise but also for the update of other web pages. Furthermore, in the description hereinafter, an example is described as an implementation in a server-client system. However, the web page manager terminal of the present invention may be a personal computer executing a program that is distributed to the client side as a Java applet or the like, and need not necessarily be a server-client system.

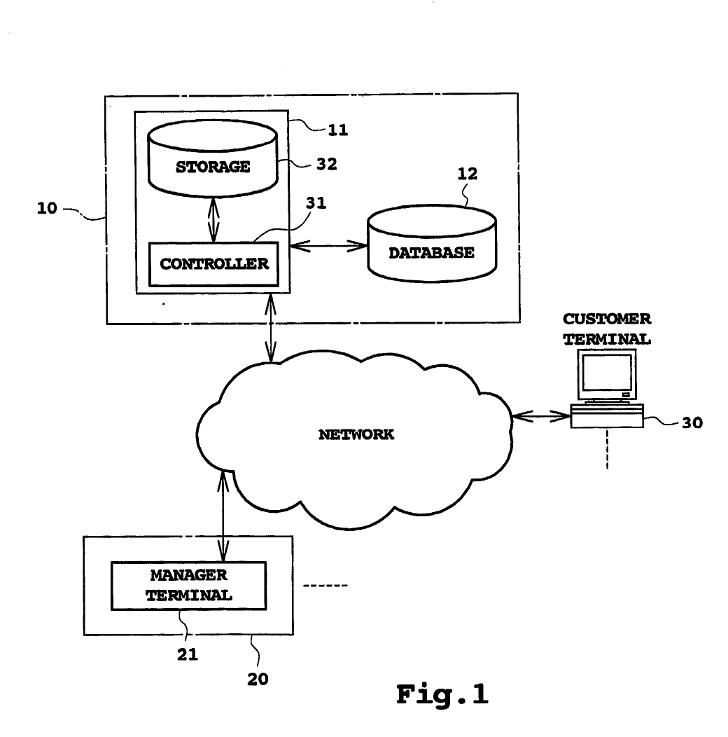

As shown in FIG. 1, the web page management support system relating to an embodiment of the present invention in an electronic commerce system includes a web server 11 and a database 12 located at an administrative organization 10 for operating a virtual shopping mall, and a manager terminal 21 located at a plurality of manager (tenant) organizations 20 for managing the web pages of individual virtual stores created in the virtual shopping mall, with the various components mutually connected via a network. Furthermore, to the network is connected a customer terminal 30 to allow access to the web server 11.

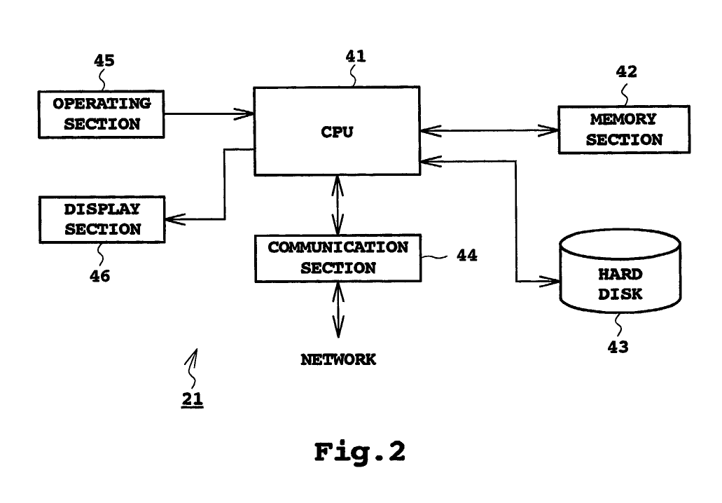

The web server 11 comprises a controller 31 and a storage 32. Furthermore, the manager terminal 21 is an ordinary personal computer, and more specifically, as shown in FIG. 2, comprises a CPU 41, a memory section 42, a hard disk 43, a communication section 44, an operating section 45, and a display section 46.

The contents of the files (collection of data) used by the system relating to the present embodiment will be described here. In the present embodiment are used a generation instruction file S utilized at the web server 11, a data definition file D provided to the web server 11 from the manager terminal 21, and a layout definition file L created to correspond to the generation instruction file and utilized by the manager terminal 21.

The generation instruction file S mainly includes information regarding content layout, information (link setting, script reference information, and so forth) defining an action in the event of an operation (click or the like) with respect to contents, and a script describing the details of the action. More specifically, the generation instruction file S may be written as a CGI (common gateway interface) program or is sometimes implemented as a Java (registered trademark) language program. Furthermore, it can also be implemented using a variety of scripting languages, such as ASP (Active Server Pages) or JavaScript.

The generation instruction file S may be held at the web server 11. For example, if a script, such as in JavaScript, is used and a web page is created at the manager terminal 21, it is possible to write a script within the source code (generally an HTML document) of the web page to cause data to load from the database 12. In this manner, the generation instruction file S may be provided to the web server 11 from the manager terminal 21 while embedded in the web page. This example of the web page being generated at the manager terminal 21 will be described hereinafter.

In the generation instruction file S, information regarding content layout is composed of area information (information on layout relationship defining an area) representing the area where content is to be arranged and an area identifier for each area.

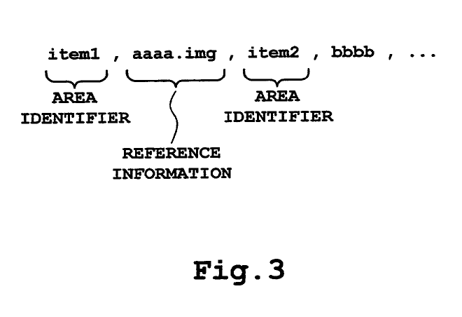

The data definition file D is basically a file correlating the area identifier with the reference information (such as a data base instruction for extracting real data from the database 12, referred to hereinafter simply as “reference information”) regarding the real data of the contents to be laid out in the area represented by the area identifier. For example, as shown in FIG. 3, this data definition file is a CSV (Comma Separated Value) file in which the area identifier and the reference information (or the real data itself) of the real data located within that area are repeated and separated by commas. The web server 11 reads the data definition file D to be processed and sequentially extracts the area identifier and the reference information (or the real data itself) of the real data to be located within that area, and selects the corresponding area identifier from the generation instruction file S. If the extracted data is the reference information, the extracted reference information is loaded into the position of the area. If the extracted data is the real data itself, the real data itself is written to the area indicated by the corresponding area identifier. In this manner, the sequentially extracted reference information or the real data is loaded to generate a web page.

The data definition file D can include information specifying a master table to be updated or information specifying a record to be updated. Namely, with respect to an area identifier, it is possible to achieve the inclusion of a master table identifier or record identifier. The master table identifier or the record identifier is used in uploading data from the manager terminal 21 or updating the database 12, and at the web server 11 is used in specifying the source of the data. Since these types of information need not appear on the web page, layout specification according to the generation instruction file S to be described hereinafter need not be included, and in reality they are not laid out. Furthermore, the data definition file D may include link settings. A more specific description of the content and handling of the data definition file D will be detailed hereinafter.

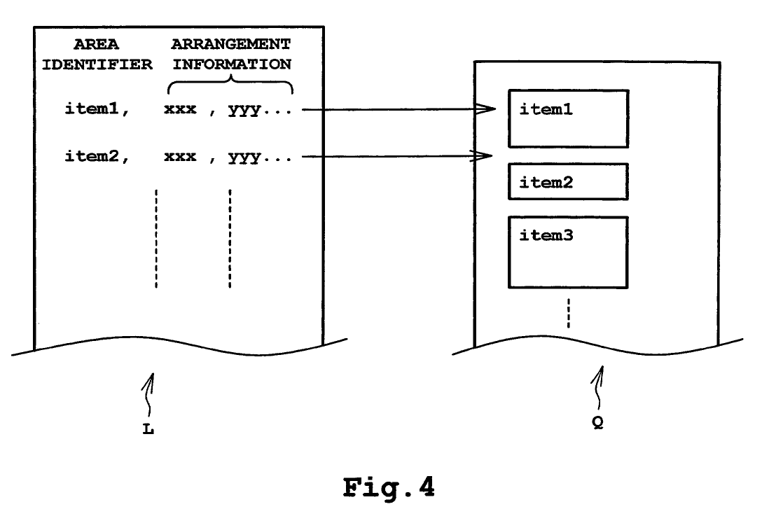

The layout definition file L includes information regarding content layout corresponding to the generation instruction file S, and as shown in FIG. 4, includes the identifiers (area identifiers) of the areas where the respective contents are to be laid out and the layout information (information defining the layout of the areas). Also included is information indicating to which master table in the database 12 the real data of the content laid out in the relevant area is to be registered. The layout definition file L is displayed (Q) on the manager terminal 21 and the manager performs tasks while viewing this display. In the system of the present embodiment, these files are used and each section operates in the following manner.

The database 12 holds the bulk (real data) of the content data provided by each tenant. Of the real data, merchandise data is registered to the merchandise master table, merchandise photographs are registered to the image master table, and so forth. The storage 32 of the web server 11 sorts and holds the data definition file D for every tenant. This sorting can be achieved, for example, by generating a directory for each tenant and storing the data definition file D into the directory of the corresponding tenant.

When the controller 31 receives the data definition file D from the manager terminal 21, the data definition file D is stored into the corresponding directory of the storage 32. When the controller 31 receives an access to a web page of a tenant from the customer terminal 30 via the network, the web page of the tenant is generated using the generation instruction file S of the corresponding web page and the real data of the content loaded from the database 12 on the basis of the data definition file D for the relevant web page. At this time, an area to which the real data of the content is not assigned by the data definition file D is not displayed. The controller 31 then sends the generated web page to the customer terminal 30 where the access originated.

There may be a plurality of data definition files D. Namely, if there is a data definition file D1 defining only the assignment of photograph content and a data definition file D2 defining only the assignment of character content, the controller 31 references each data definition file D1 and D2, lays out the real data of the content of the photograph and character, and generates the final web page including the photograph and character.

The CPU 41 of the manager terminal 21 executes programs installed on the hard disk 43 or programs obtained via the network through the communication section 44, and performs a process for displaying the layout definition file L, a process for generating the data definition file D, and a process for sending the generated data definition file D to the web server 11. Specific details of these processes will be described hereinafter.

The memory section 42 operates as work memory for the CPU 41. The hard disk 43 stores programs that are executed by the CPU 41. The hard disk 43 also holds various types of data. The communication section 44 is a modem or a network card that is connected to a network, and sends and receives data via the network according to instructions that are input from the CPU 41. The operating section 45 is a keyboard or a mouse and outputs to the CPU 41 the nature of the operation performed by the user. The display section 46 is a display unit and displays information according to instructions that are input from the CPU 41.

The various processes of the CPU 41 will be described here in detail. The hard disk 43 stores image data, obtained by photographing (such as with a digital camera) the merchandise to be sold, as a candidate for real data of the content with a file name attached. The CPU 41 starts a process to display the layout definition file L according to instructions from the user. The CPU 41 downloads from the web server 11 the layout definition file L that was indicated by the user and stores it into the hard disk 41. The CPU 41 then displays this layout definition file L on the display section 46. This display is performed by loading the information on the area within the layout definition file L and displaying the layout condition of each area. During this display, the CPU 41 displays area outlines representing the shape of each area.

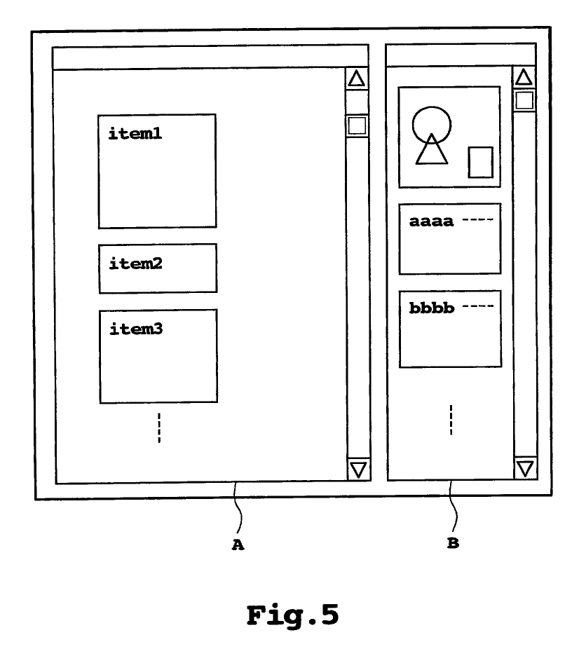

Furthermore, the CPU 41 searches within the hard disk 43 and displays a list of image data (thumbnails) as candidates of real data of the content. As a result, a window (A) including area outlines representing the layout of the content and a window (B) including a list of thumbnails of the real data are displayed on the display section 46 as shown in FIG. 5.

In this process, the CPU 41 places into the memory section 42 a table for correlating the various area identifiers with the information representing the real data displayed within the areas corresponding to the respective area identifiers. When an operation is performed to correlate a real data candidate to an area surrounded by any of the area outlines, the table held in the memory section 42 is updated, and the file name of the real data is correlated to the area identifier of the area relating to the relevant operation and registered. It is preferable to use an operation to drag-and-drop a thumbnail from the window (B) to an area within an area outline for the operation to correlate the area with the real data candidate. Furthermore, when this operation is performed for the case where the real data corresponding to the relevant thumbnail is image data, the CPU 41 performs processing to reduce or enlarge the image to match the area for display within the area.

Furthermore, when an operation is performed to enter text data into an area surrounded by any of the area outlines, the CPU 41 updates the table held in the memory section 42, and correlates and registers the relevant text data with the area identifier of the area relating to this operation.

The layout definition file L may include the type of data (image or text) that is acceptable in each area as a data type attribute in the information for that area. In this case, if an operation is attempted to correlate the real data of an image to an area that has been set with a data type attribute to accept text, the CPU 41 issues an error display on the display section 46 to the effect that such an operation is not possible.

When an input indicating the completion of content correlation is received from the operating section 45, the CPU 41 starts a process to generate the data definition file D, references the table stored in the memory section 42, and uploads and registers to the database 12 the real data correlated to each area. Furthermore, when the real data is directly written to a content acceptable area, the real data is held in the memory section 42. The file name of the real data in the table stored in the memory section 42 is changed to the reference information of the relevant real data, and while referencing the table after this change, the area identifier of each area and the reference information of the real data correlated to that area, or the area identifier and the real data itself held in the memory section 42 when the real data itself is correlated with the area, is written to the hard disk 43 in the format of a CSV file. The CSV file becomes the data definition file D. When registering the real data to the database 12, the CPU 41 references information identifying the master table that is correlated to each area and updates the relevant master table.

By registering to the database 12 the store name (set in advance) and the file name as keys, the change to the reference information can be performed easily on the basis of file name.

When the CPU 41 generates the data definition file D, the data definition file D is uploaded to the storage 32 of the web server 11. The data definition file D is then referenced by the web server 11 and the web page is generated.

In this manner, according to the present embodiment, the manager of the store lays out the content while referencing the display of the layout definition file L that indicates the content layout of the web page so that the real data of the content can be registered to the database 12 and the web page can be updated at the same time. This can be performed by a simple operation of pasting the real data of the content with the display of the layout definition file L as a “template”, and each time the real data is pasted, the state of the updated web page can be previewed interactively for improved convenience.

[Grouping of Areas]

A further characteristic in the present embodiment is that a plurality of layout definition files L may be generated for one page, namely, for one generation instruction file S. Thus, to generate a web page including merchandise image data content (data to be registered in the image master table) and text data content indicating the selling price of each merchandise (data to be registered in the merchandise master table), the areas can be grouped into an area group (first area group) for accepting merchandise image data content and an area group (second area group) for accepting text data content for the selling price. Using a layout definition file L1 that includes area information on the areas of the first area group and the area identifiers, and a layout definition file L2 that includes area information on the areas of the second area group and the area identifiers, the manager terminal 21 generates and uploads to the web server 11 the data definition files D1 and D2 for each layout definition file. As already described, the web server 11 references these data definition files D1 and D2 to generate one web page.

In this manner, a designer for taking and selecting merchandise photographs at the store can correlate the real data to the first area group using the layout definition file L1 and a manager for deciding the selling price can correlate the real data to the second area group using the layout definition file L2 so that the management of a web page matching the actual situation of the tenant can be performed. Furthermore, a characteristic of the present embodiment is that the areas can be grouped depending on the area information and the area identifier of the area to be included within the layout definition file L. As a result, the areas are grouped, and a layout definition file L is generated for each area group to make it easy to match the actual situation at the tenant side.

When areas are grouped in this manner, it is further possible to set certain master tables to be updated for every area group instead of certain master tables to be updated for every area.

Furthermore, when the areas have been grouped, the convenience is improved and it is not necessary to be conscious of a plurality of master tables in the database 12 since the CPU 41 of the manager terminal 21 selectively updates the master table according to the specified master table (specified master table related to each area or each area group) included in each layout definition file L.

[Changing Content Layout]

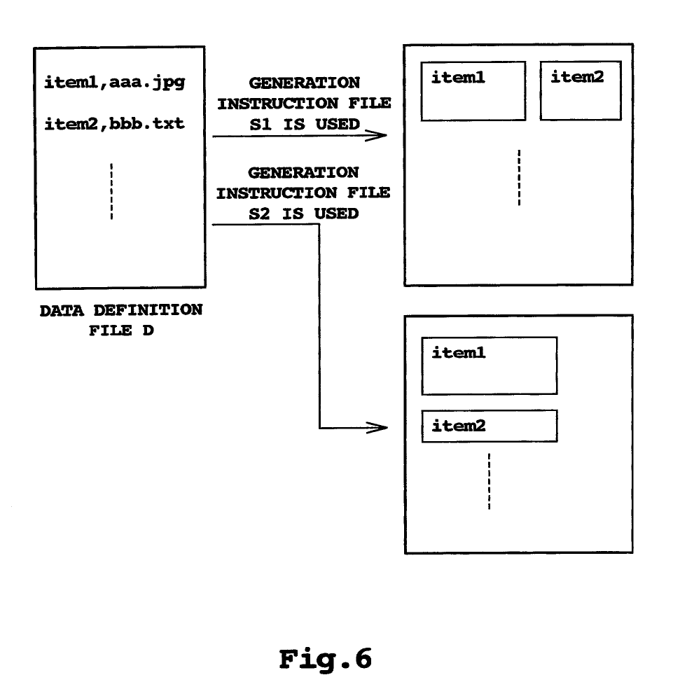

Furthermore, a characteristic of the embodiment is that the content layout can be changed without changing the data definition file D even though a different generation instruction file S is used, provided the same area identifiers are included, since the data definition file D only includes information correlating the area identifier with the reference information of real data to be laid out within the area identified by the area identifier. More specifically, a generation instruction file S1 for generating a web page in which the areas with area identifiers “item1” and “item2” are arranged horizontally, and a generation instruction file S2 for generating a web page in which the areas with area identifiers “item1” and “item2” are arranged vertically can use the same data definition file D (FIG. 6).

[Frame]

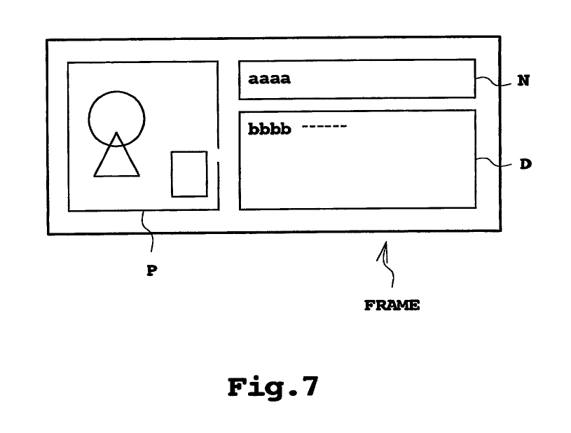

On an actual web page containing an image of merchandise as shown in FIG. 7, image data (P), a character string (N) of the merchandise name, and descriptive text (D) are used per single merchandise item. As a set, this is repeated and arranged for the number of merchandise items. Usually, this information is frequently replaced per merchandise unit in accordance with the sales situation and inventory of the merchandise. Therefore, it is convenient if the layout of a web page can be managed per merchandise unit.

This can be achieved by making it possible to lay out as a unit an area set formed from a plurality of areas (such as an area set of three areas P, N, and D corresponding to one merchandise item). In the present embodiment, a frame defining the area set is determined, and the arrangement of each frame is also defined in the layout definition file L. In this case, the arrangement of each area included in the frame may be defined in a coordinate system within the frame. Furthermore, in this case, a frame identifier is set to each frame, and for the areas within the frame, the frame identifier is included in the area identifier. For example, if the frame identifier of the first frame is “Frame1”, the area identifier of the area included in the first frame becomes “Frame1_Item1”.

Once this is done and when it is desirable to change the assignment of the real data, it is only necessary to change the frame identifier for the assignment. For example, when changing the arrangement order of merchandise when the first merchandise is assigned to the first frame (identifier of Frame1) and the second merchandise is assigned to the second frame (identifier of Frame2), the current “Frame1” is changed to “Frame2” and the current “Frame2” is changed to “Frame1” for the area identifiers assigned with real data. As a result, changing the order of the merchandise becomes easy. Similarly, web page management becomes easy with the merchandise as a unit, such as when replacing merchandise, deleting merchandise information, and so forth. Furthermore, instead of correlating the designation of the master table to be updated to each area or area group, the designation of the master table may be correlated for every frame. For example, the area within “Frame1” can be defined for the merchandise master table and the area within “Frame2” can be defined for the image master table.

[Operation]

The operation of the web page management support system of the present embodiment will be described next. The administrative organization 10 for operating the shopping mall designs various web pages in advance and creates the generation instruction files S1, S2, and so forth, for each design, and the layout definition files L1, L2, and so forth, in which the content acceptable areas are arranged on the basis of the same design with each generation instruction file S. Furthermore, the layout definition file L is made available on the network so as to be downloadable by a manager. Namely, in this case, the generation instruction file S is held at the web server 11.

The manager downloads the layout definition file L containing a desirable design from among the layout definition files L, starts up the web page management support program, performs operations to correlate the real data of the contents to each acceptable area while viewing the layout of the content acceptable areas and the thumbnails of the real data of the contents, and generates the data definition file D.

At this time, the layout definition file L includes layout information on frames that organize a set of content acceptable areas for each merchandise. If the manager wishes to change the displayed order of the merchandise, such as during an operation for content correlation, exchanging the positions of the frames causes the manager terminal 21 to update the data definition file D by rewriting the frame identifier of the area identifier in the description of the data definition file D and changing the displayed order.

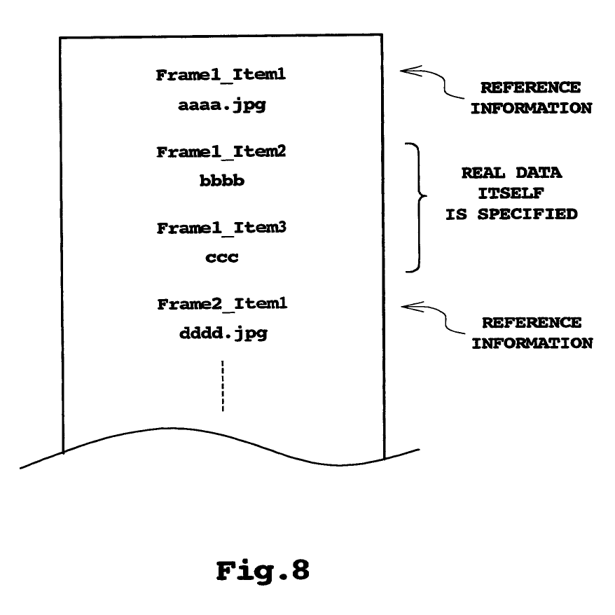

The data definition file D generated in this manner is shown in FIG. 8. The manager uploads the data definition file D generated in this manner to the web server 11 and stores the real data of the required contents into the database 12.

As a result, when the web page is referenced, the web server 11 generates and provides the web page by referencing the corresponding generation instruction file S and the data definition file D. At this time, regarding the image data among the real data of content, for example, a size reduction process is performed to match the size of the correlated area. If the horizontal and vertical dimensions are different, the reduction process reduces the size without changing the proportion, and reduces the size based on the longer of the horizontal and vertical dimensions.

Regarding the layout definition file L, a plurality of layout definition files L may be generated and downloaded at the administrator side, such as a layout definition file La which is set only with the areas accepting image data and a layout definition file Lb which is set only with the areas accepting data on the selling price of merchandise, and a web page may be generated on the basis of the data definition file D that is generated from the layout definition files La and Lb.

Furthermore, in the description so far, only the case for managing a specific web page within a web site, such as a web page introducing merchandise, was described. However, it is also possible to respectively generate the data definition file D for generating various web pages by including the information identifying the web page into the data definition file D.

In this case, when the web server 11 receives an instruction to reference the web page, each data definition file D is referenced, and the data definition file D corresponding to the indicated web page is selected. Using this data definition file D and the generation instruction file S, the web page is then generated. As to which generation instruction file S is to be used, the information on which layout definition file L was downloaded may be referenced, or a separate instruction may be received. As a result, it is possible to generate not only a merchandise introduction page but also a page showing content information besides that of the merchandise.

Furthermore, in this case, there are instances where it is desirable to update not only the merchandise master table but a master table (such as a customer master table) that manages other content information. Thus, the database 12 in this case references the data definition file D that was uploaded to the web server 11, checks the area identifier (or frame identifier of a part thereof) that was assigned for the respective real data, and distributes and registers the respective real data to the respective master tables. For example, when frame identifier “Frame101” is correlated with the content display and “Frame1” is correlated with the merchandise information display, the real data correlated with “Frame1” is registered in the merchandise master table and the real data correlated with “Frame101” is registered in the master table type that manages the content information. For each frame identifier, information is set in advance for indicating the master table to which is registered the real data correlated to the frame identifier.

[Link Setting based on the Data Definition File]

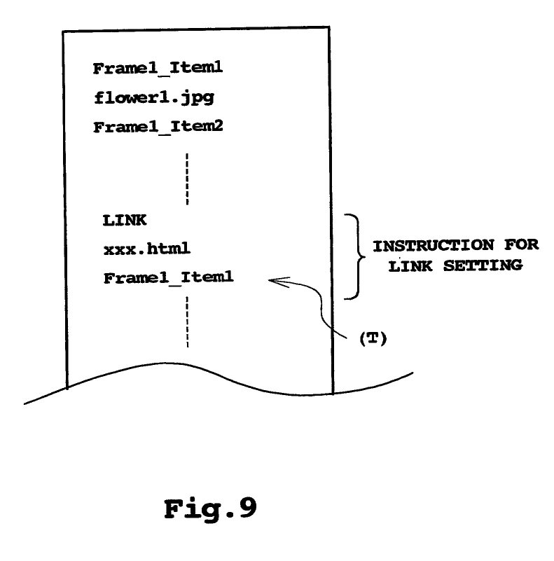

In the description so far, the link settings were specified by the generation instruction file S. However, the link settings may be included in the data definition file D. More specifically, as shown in FIG. 9, which corresponds to FIG. 8, the “LINK” declaration signifying a link setting, the reference information, such as the URL (Uniform Resource Locator) of the link destination, and an instruction (T) for the target representing the frame (area) to which the link is to be set are included in the data definition file D. The web server 11 references the link setting within the layout definition file and sets a link to the real data to be laid out in the corresponding frame. For example, as shown in FIG. 9, if a statement correlating the real data “flower1.jpg” to the frame identifier “Frame1_Item1” is included in the data definition file D, and an instruction correlating the link “xxx.html” with the frame identifier “Frame1_Item” as a target is included, the link “xxx.html” is set to the image data of “flower1.jpg”. Namely, the <a href=“xxx.html”><img src=“flower1.jpg”></a> tags are included as the HTML (HyperText Markup Language) commands. Although the declaration of the link setting is indicated here by a keyword such as “LINK”, a URL may be correlated with the area identifier.

[File Generation at the Manager Side]

Again, in the description so far, the generation instruction file S and the corresponding layout definition file L were generated at the side operating the electronic commerce system. However, if the manager terminal 21 of the present embodiment is used in creating a personal web page and not the electronic commerce system, the generation instruction file S and the layout definition file L may be created at the manager terminal 21. More specifically, a program is installed at the manager terminal 21 and includes a web page editing software module (editing module) for adjusting the layout of the various contents, and into the HTML description of the web page written by the module, a module (embedding module) for respectively embedding script (generation instruction script) for the generation instruction file S and script (layout definition script) for the layout definition file L to generate the generation instruction file S and the layout definition file L.

The manager terminal 21 adjusts the layout of the contents and writes it as HTML code by an operation similar to that of ordinary web page editing software (such as GoLive (registered trademark) by Adobe Systems Incorporated) according to instructions by the manager. At this time, the embedding module adds the generation instruction script to the HTML code to generate the generation instruction file S. This script is, for example, a script for obtaining and embedding the real data of content from the database 12 according to the description of the data definition file D. Furthermore, the embedding module embeds the layout definition script into the written HTML code to generate the layout definition file L.

A module may be included for generating the layout definition file L by using a generation instruction file S generated in advance and replacing the generation instruction script with the layout definition script. As a result, generating a layout definition file L using a generation instruction file S that was designed by someone else makes it easy to create a web page based on the same design.

[Web Page Creation at the Manager Side]

Furthermore, in the description so far, an example was described where the web server 11 dynamically generates web pages on the basis of the generation instruction file S and the data definition file D. However, the manager terminal 21 may create an HTML description of a web page from a data definition file D generated by the manager performing an operation using a layout definition file L, and a generation instruction file S corresponding to the layout definition file L that was used, store it into the storage 32 of the web server 11, and provide the relevant HTML description as a web page to the web server 11. The manager terminal 21, when storing the HTML file in the storage 32, registers the real data of the contents referenced from the HTML description of the relevant HTML file into the database 12, and converts the reference information of the real data of the relevant contents included as an HTML description to data representing the storage locations of the real data within the database 12.

[Sharing of a Master Table Among a Plurality of Stores]

In the description so far, it was assumed that a separate master table group (group formed from a plurality of master tables, such as merchandise master table and image master table) within the database 12 was prepared for every store. However, a master table may be shared among a plurality of stores. In this case, each record (unit correlating key and data) within a master table must indicate to which store its data belongs. Information (such as store identifier for store master table) for identifying the record is then included in the data definition file D.

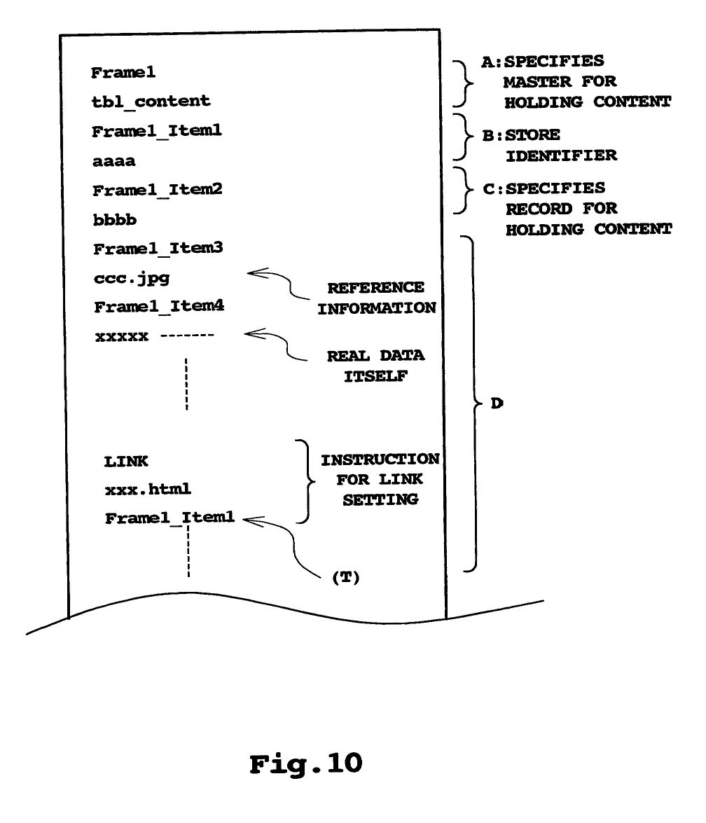

More specifically, as shown in FIG. 10, the information for identifying a record is correlated, similar to other information, to an area (virtual area that is not displayed) and included in a data definition file D. In FIG. 10, the data definition file D declares (A) that frame “Frame1” is related to the update of master table “tbl_content”, area “Frame1_Item1” corresponds to a store identifier (B), and area “Frame1_Item2” corresponds to information identifying a record in the image master table (C). Also, the area after “Frame1_Item3” is related to the real data of the content (D). This part relating to the real data of the content may include a link setting. In this case, the link setting may relate not only to reference information (file name) of the real data of content but to an area identifier (name such as “Item3”) as shown in FIG. 9. The link specified in this case is added to the real data of the content correlated to the relevant area identifier.

In this case, not including “Frame1_Item1” and “Frame_Item2” at the generation instruction file S means they are not included in the web page. The web server 11 references the information identifying the master table included in the data definition file D and the information identifying the record, loads the data from the relevant record of the relevant master table, and arranges it on the web page.

The following basic examples are given for updating the database that stores the web page and the content provided on the web page. In the first example, the layout definition file L is distributed from the administrator of an electronic commerce site. Using this layout definition file L, the content acceptable areas are prescribed, and the manager at the manager terminal 21 correlates content to the acceptable areas to generate the data definition file D to become the source of the web page generation. The data definition file D is uploaded to the web server 11 and the correlated content is stored in the database 12. Using the generation instruction file S that corresponds to the layout definition file L at the web server 11, the content is loaded from the database 12 and the laid out web page (source of which is an HTML document) is generated.

In the second example, the layout definition file L including the storage position of data of the manager within the database 12 from the administrator of an electronic commerce site is distributed. The content acceptable areas are prescribed by the layout definition file L and the manager at the manager terminal 21 correlates the content with the acceptable areas to generated the data definition file D to become the source of the web page generation. At this time, the master table identifier and record identifier are included within the data definition file D, and at the manager terminal 21, the master table identifier and record identifier are referenced and the content is stored in the corresponding master table or record of the database 12. The data definition file D is then uploaded to the web server 11, the generation instruction file S is referenced at the web server 11, and content is extracted from the corresponding master table or record and laid out according to the data definition file D to generate the web page.

In the first example, the layout definition file L does not necessarily have to be distributed from the administrator. Furthermore, in the second example also, if the master table identifier and the record identifier are known separately and settable at the manager side, the layout definition file L may be obtained from someone other than the administrator.

Furthermore, in the third example, the web page is generated at the manager terminal 21. Using the layout definition file L, the content is correlated with the acceptable areas at the manager terminal 21, thus generating data to correspond to the data definition file D to become the source of the web page generation. The generation instruction file S corresponding to the layout definition file L is further referenced, and the web page is generated using the data. At this time, the script (corresponding to the generation instruction file S) prescribing the layout of the content within the web page is loaded into the HTML description, which is the source code of the web page. The web server 11 accepts and provides this web page.

In the third example, it is not necessary for content, such as image data, to be stored in the database 12. If a direct path (storage location) is written in the HTML document, it may be stored at a location indicated by the path. Most importantly, by writing an instruction, such as in Java (registered trademark), to extract the data from the database 12, the data can also be stored in the database 12.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A web page management support system comprising a database that stores real data of content, a web server, and a manager terminal disposed at a manager side of a web page;
said manager terminal including;
a device for presenting to a manager a layout definition file that includes layout information on a content acceptable area and corresponds to a generation instruction file;
a device for generating according to instruction of a manager a data definition file for correlating real data of content with said content acceptable area; and
a device for sending said data definition file to said web server;
wherein real data of content is loaded from the database on the basis of the data definition file, and the web page that is laid out according to the generation instruction file is provided by said web server.

2. A web page management support system according to claim 1, wherein a plurality of said content acceptable areas are grouped among a plurality of area groups, a plurality of layout definition files having layout information of the acceptable areas of the area group are defined for every area group;
said manager terminal generates a plurality of data definition files corresponding to respective layout definition files;
real data of content is loaded from the database on the basis of said plurality of data definition files and laid out according to the generation instruction file, and a web page for which link setting was performed is provided by said web server.

3. A web page management support apparatus that is connected to a database storing real data of content and to a web server, comprising:
a presenting device for presenting to a manager a layout definition file that includes layout information of content acceptable area and corresponds to a generation instruction file;
a generating device for generating according to user instruction a data definition file that correlates the real data of content to said content acceptable area; and
a sending device for sending said data definition file to said web server;
wherein the real data of content is loaded into the database on the basis of the data definition file, and a web page that is laid out according to the generation instruction file is provided from said web server.

4. A web page management support apparatus according to claim 3 further comprising a device for page design for outputting said generation instruction file and a data definition file corresponding to said generation instruction file.

5. A web page management support apparatus according to claim 3, wherein said generating device generates a data definition file to include an instruction for setting a link to at least one content acceptable area.

6. A web page management support apparatus according to claim 3, wherein:
each of a plurality of said acceptable areas is grouped in one of a plurality of area groups, a plurality of layout definition files are defined as having layout information of acceptable areas of area group for every area group;
said generating device generates a plurality of data definition files corresponding to respective layout definition files;
real data of content is loaded from the database on the basis of said plurality of data definition files, and a web page laid out according to the generation instruction file is provided from said web server.

7. A web page management support method that uses a database storing real data of content and a web server, comprising:
a process for presenting to a manager a layout definition file that includes layout information of content acceptable area and corresponds to the generation instruction file;
a process for generating a data definition file according to instruction of a manager for correlating the real data of content to said content acceptable area; and
a process for sending said data definition file to said web server;
wherein real data of content is loaded from the database on the basis of the data definition file and laid out according to the generation instruction file, and a web page for which link setting was performed is provided from said web server.

8. A program stored in a computer connected to a database storing real data of content and comprising computer readable media, and to a web server, said program executing the following steps of:
presenting to a manager a layout definition file that includes layout information of content acceptable area and corresponds to a generation instruction file;
generating a data definition file for correlating real data of content with said content acceptable area according to instruction of a manager; and
sending said data definition file to said web server;
wherein real data of content is loaded from the database on the basis of the data definition file, and laid out according to the generation instruction file, and the web page for which link setting was performed is provided to said web server.

9. A providing method for a web site provider service, using a database storing real data of content and a web server, comprising:
a process for providing to a manager side a layout definition file that includes layout information of content acceptable area and corresponds to a generation instruction file; and
a process for accepting from the manager the data definition file correlating the real data of content with said content acceptable area;
wherein real data of content is loaded from the database on the basis of said data definition file and laid out according to the generation instruction file, and a web page for which link setting was performed is provided from said web server.
